(19) United States
(12) Patent Application Publication
(10) Pub. No.: US 2016/0232612 A1
(43) Pub. Date: Aug. 11, 2016

(54) METHOD AND SYSTEM FOR MONITORING COMMODITY NETWORKS THROUGH RADIOFREQUENCY SCANNING

(71) Applicant: Genscape Intangible Holding, Inc., Louisville, KY (US)

(72) Inventors: Josef Spalenka, Louisville, KY (US); Deirdre Alphenaar, Prospect, KY (US)

(21) Appl. No.: 15/040,754

(22) Filed: Feb. 10, 2016

Related U.S. Application Data
(60) Provisional application No. 62/114,864, filed on Feb. 11, 2015.

(51) Int. Cl. G06Q 40/04; H04L 29/08; H04W 84/18; H04L 12/26

(52) U.S. Cl. CPC G06Q 40/04; H04L 43/10; H04L 67/12; H04W 84/18

(57) ABSTRACT

In the method and system of the present invention, a monitoring device (or monitor) is positioned at a predetermined location for monitoring a pipeline or other component of a network for supply, transfer, or demand of a commodity. A radio receiver of the monitor is used to receive radiofrequency waves from one or more supervisory (or control) devices associated with the network. Then, the radiofrequency waves are demodulated and converted into a digital data stream. The digital data stream is then separated into discrete data packets, with reference being made to a database in order to identify and decode the discrete data packets. The discrete data packets are then processed to determine information about the commodity relative to the component, such as the flow rate of the commodity through a pipeline. Such information is then communicated to interested parties.

### CROSS-REFERENCE TO RELATED APPLICATIONS

The present application claims priority to U.S. Patent Application Ser. No. 62/114,864 filed on Feb. 11, 2015, which is incorporated herein by reference.

### BACKGROUND OF THE INVENTION

The present invention relates to a method and system for monitoring commodity supply, transfer, and demand networks by scanning the radiofrequency emissions from components of these networks.

Commodities, including, for example, power, natural gas, crude oil, other liquid or gas energy commodities, and water, are bought and sold by many parties, and as with any traded market, information about the supply of, demand for, and transfer of traded commodities is valuable to market participants or other interested parties. Specifically, the operations of the various components of the production, transportation, storage, and distribution systems for such commodities can have significant impacts on the price and availability of these commodities, making information about said operations invaluable. In other words, fundamental information about such operations are key drivers in commodity pricing, so, in order to gain insight into market and pricing information, it is important to have accurate measurements of and understand the networks involved in all aspects of the commodity supply chain. Furthermore, such information generally is not disclosed publicly by the various component owners or operators, and access to said information is therefore limited.

### SUMMARY OF THE INVENTION

The present invention is a method and system for monitoring commodity supply, transfer, and demand networks by scanning the radiofrequency emissions from components of these networks.

In the method and system of the present invention, monitoring devices (or monitors) are used to scan radiofrequency waves transmitted from meters, gauges, and other supervisory (or control) devices associated with components of a network. For example, metered points along a pipeline can be monitored, thus allowing for monitoring of flow rates into and out of the pipeline or other network component connected with the pipeline, along with the monitoring of other physical and/or quality parameters associated with the network and the commodity flowing through the network, but without direct access to network infrastructure. Such meters, gauges, and other supervisory devices may be associated with commodity and energy facilities, including, but not limited to: natural gas and crude oil pipelines; natural gas and crude oil delivery and receipt points; pumping stations for natural gas, crude oil, or other liquid energy commodities; natural gas meters at industrial end users, such as fertilizer and steel plants; residue gas outlets at gas processing plants; wastewater treatment plants; electric substations and grid meters; and inlets and outlets of natural gas liquid (NGL) processing facilities, such as NGL fractionators; and water and liquid energy storage facilities.

An exemplary implementation of the method of the present invention commences with the positioning of a monitor at a predetermined location for monitoring a pipeline or other component of a network for supply, transfer, or demand of a commodity. Once a monitor is positioned at the predetermined location, a radio receiver of the monitor is used to receive radiofrequency waves from one or more supervisory devices associated with the network. Then, the radiofrequency waves are demodulated and converted into a digital data stream. The digital data stream is then separated into discrete data packets, with reference being made to a database in order to identify and decode the discrete data packets. The discrete data packets are then processed to determine information about the commodity relative to the component, such as the flow rate of the commodity through a pipeline. Such information is then communicated to interested parties. For instance, such communications to interested parties can be achieved through electronic mail delivery and/or through export of the data to an access-controlled Internet web site.

With respect to the step of processing the discrete data packets to determine information about the commodity, in some implementations, this step is performed at a central processing facility. As such, the discrete data packets are transmitted to the central processing facility before the step of processing the discrete data packets.

In other implementations, the digital data stream is transmitted to a central processing facility for both the step of separating the digital data stream into discrete data packets and the step of processing the discrete data packets to determine information about the commodity.

In one example, a monitor is used to receive radiofrequency waves from a supervisory device associated with a natural gas pipeline. The digital data stream is separated in discrete data packets that typically contain preamble information in the message header, including start-of-transmission codes, routing information for the source and destination of the data packet, and information about the total number of data bytes contained in the message. The data packets also typically contain footer information, including end-of-transmission codes, and error checking codes to ensure error-free data transmission. The central portion of the data packets contains the data payload, which includes certain data about the natural gas passing through the pipeline, including, for example, instantaneous volumetric flow in MMCF/day; instantaneous energy flow in BTUs/day; accumulated gas volume delivered so far for that day in MMCF; accumulated energy delivered so far for that day in BTUs; total gas volume delivered yesterday in MMCF (million cubic feet); and total energy delivered yesterday in BTUs.

Once the flow rate and/or other information about the flow of natural gas through the pipeline has been determined, the flow rate and/or other information is then communicated to interested parties. As mentioned above, such communications to interested parties can be achieved through electronic mail delivery and/or through export of the data to an access-controlled Internet web site. Additionally, for any particular natural gas network for which all, or most of, the connected pipelines are monitored in accordance with the present invention, the natural gas flow rate into or out of the network can be determined through a summing of the flow rates on each pipeline, which can also be communicated to interested parties.

### DESCRIPTION OF THE DRAWINGS

FIG. 1 is a network map diagram that illustrates an exemplary network of meters along a pipeline, each of which are in radio communication with a master station;

FIG. 2 is a schematic view of an exemplary monitor for use in the method and system of the present invention;

FIG. 2A illustrates the positioning of a supervisory device on a pipeline; and

FIG. 3 is a flow chart illustrating an exemplary implementation of the method of the present invention.

### DETAILED DESCRIPTION OF THE INVENTION

The present invention is a method and system for monitoring commodity supply, transfer, and demand networks by scanning the radiofrequency emissions from components of these networks. Specifically, in the method and system of the present invention, monitoring devices (or monitors) are used to scan radiofrequency waves transmitted from meters, gauges, and other supervisory (or control) devices associated with components of a network. For example, metered points along a pipeline can be monitored, thus allowing for monitoring of flow rates into and out of the pipeline or other network component connected with the pipeline, along with the monitoring of other physical and/or quality parameters associated with the network and the commodity flowing through the network, but without direct access to network infrastructure. Such meters, gauges, and other supervisory devices may be associated with commodity and energy facilities, including, but not limited to: natural gas and crude oil pipelines; natural gas and crude oil delivery and receipt points; pumping stations for natural gas, crude oil, or other liquid energy commodities; natural gas meters at industrial end users, such as fertilizer and steel plants; residue gas outlets at gas processing plants; wastewater treatment plants; electric substations and grid meters; and inlets and outlets of natural gas liquid (NGL) processing facilities, such as NGL fractionators; and water and liquid energy storage facilities.

To accomplish this, it is first important to recognize that the production, transportation, storage, and distribution of many commodities, including, but not limited to, liquid or gas energy commodities, occur through networks of pipelines. These pipelines connect various system components, such as production wells, storage facilities of various types, refineries, processing plants, and distribution networks comprised of ever-smaller pipelines. In general, the flow of fluids flowing through pipelines or similar conduits is measured for flow rates, fluid pressures, fluid quality parameters, temperature, pipeline conditions, and so on, and the data collected from an array of meters controlling and supervising the network is relayed back to one or more central control locations.

With respect to the relay of such data back to one or more central control locations, data is commonly transmitted utilizing radiofrequency (RF) bands in some form of Supervisory Control and Data Acquisition (SCADA) system. Allocations and permitted uses for radiofrequency bands are commonly defined and regulated by governmental organizations, such as the Federal Communications Commission (FCC) in the United States. Transmissions are typically in bands ranging from 100 MHz HF radio bands to fixed microwave UHF bands up to 1 GHz. Transmissions may also be made via satellite communications at frequencies higher than 1 GHz.

Radiofrequency-based SCADA systems can vary from simple point-to-point implementations where a single radiofrequency transceiver communicates with a single dedicated central control location to complex multi-point radiofrequency network configurations. These radiofrequency networks can be configured in a number of ways; for example, one common configuration is a Multiple Address System (MAS) configuration. In a MAS configuration, a master station communicates with a number of remote radio stations within its radio horizon, typically within a 30 to 40 mile radius. To avoid data collisions, i.e., attempted simultaneous message transmissions resulting in unintelligible data, MAS systems are typically operated as a poll-and-response system, where the master station controls data flow by making data requests from the remote radio stations on a fixed polling cycle. The remote radio stations then respond one at a time with updated data from the meters, gauges, and other supervisory devices of the commodity network. Typically, master-to-remote polls and remote-to-master responses occur on separate radio frequencies. Physical information measured at the meters, gauges, and other supervisory devices is typically transmitted on the remote-to-master frequency. However, in some limited cases, the master-to-remote frequency is also used to forward information from other parts of the network, such as fluid composition as measured by an upstream gas chromatograph, that is then used to make flow, energy content, and density calculations in downstream portions of the network.

Because MAS systems typically operate as a cellular network, consisting of individual partially-overlapping radio coverage zones with limited radio horizons and operating on different sets of frequencies, adjacent remote radio stations on a network may report to different master stations that may be as far as 80 miles apart from each other. Therefore, the radio network and the MAS communications layer network form a combined network, in which particular remote radio stations must be matched to their corresponding master stations. A functional mapping between master and remote stations (or nodes) onto the overlaying data relay layer is governed by a network of radiofrequency transmit and receive points.

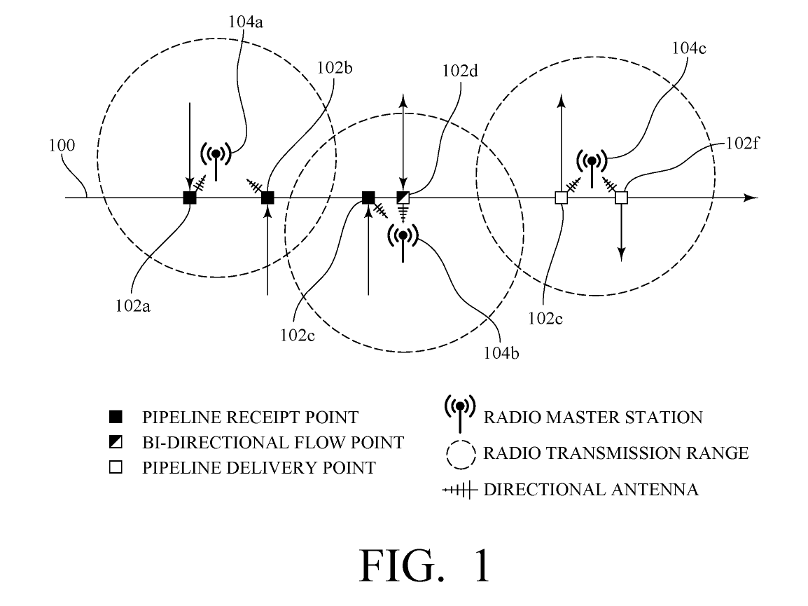

FIG. 1 is a network map diagram that illustrates an exemplary network of meters 102a-f (which are remote radio stations) along a pipeline 100, each of which are in radio communication with a master station 104a-c. As shown in FIG. 1, the radio horizon of each master station 104a-c is represented by a dashed circle, and the meters within the radio horizon would communicate with that master station 104a-c. Maps of pipelines and associated network components in a supply chain are often available in the public domain, such as the National Pipeline Mapping System (see http://www.npms.phmsa.dot.gov/PublicViewer/) and the Texas Railroad Commission public GIS viewer (see http://wwwgisp.rrc.state.tx.usGISViewer2/). Maps and other information showing the geo-location of meters and master stations are also commonly available from commercial sources, such as the websites of individual pipeline operators and in the Federal Communications Commission (FCC) Universal Licensing System database (see http://wireless2.fcc.gov/UIsApp/UIsSearch/searchAdvanced.jsp), However, such maps do not associate such meters and master stations (i.e., the radiofrequency transmit and receipt points) with points or physical components on a commodity supply chain. In order to derive a more complete understanding of commodity transfer across a network, the radiofrequency network maps showing the location of the radiofrequency transmit and receipt points must be registered against a physical network map of a commodity supply chain. Once the radiofrequency network is registered against the physical network, the data collected using the methods described herein can then be mapped and aggregated as needed to not only report basic information (such as flow rate through a particular pipeline or past a particular point), but also to develop a commodity transaction map between different parts of a single network, or transfer between networks owned and managed by different owner-operators or between different market regions.

Delivery and receipt rates, along with the parties involved in gas transfer transactions, is generally not available to market participants. Since any transaction between two or more parties generally requires reporting of all the data associated with the transaction to each party, it is not uncommon for all parties in a transaction to use radiofrequency transmissions to communicate on commodity transfers. In some cases, a single meter station can contain radios delivering this information to one or more parties on independent radio networks. Once the radio layer is understood as described herein, this radio network can be used to indicate the parties who are involved in receiving transactional data and therefore what parties are performing transactions. For instance, in FIG. 1 the owner of pipeline 100 will perform gas transfers with other pipelines interconnected with pipeline 100. By tracking radiofrequency communications at these pipeline interconnections, the identity of the receiving pipeline and party can be established as well as the direction of the transfer, that is, whether the transaction is a delivery or a receipt.

Network operators utilize RF transceiver equipment to suit their particular needs and acquire transceiver equipment from any number of radio manufacturers. These manufacturers produce radio transmitters and receivers that operate within the regulated RF bands licensed for use in SCADA systems. A scanning radio receiver or a network of scanning radio receivers can be deployed to collect radiofrequency waves and carrier data, and this data can be used to generate a real-time model of network activity to include, but not limited to, whether flows are present or not, relative flow volumes, direction of flow into and out of associated network entities such as storage and processing facilities, and quality and type of commodity flowing. For instance, one or more scanning radio receivers can be positioned to detect the radiofrequency waves emanating from a meter associated with a particular pipeline, where these waves contain data on the fluid flow through that pipeline. By recording and analyzing the radiofrequency waves, the flow rate and other flow parameters through the pipeline can be determined.

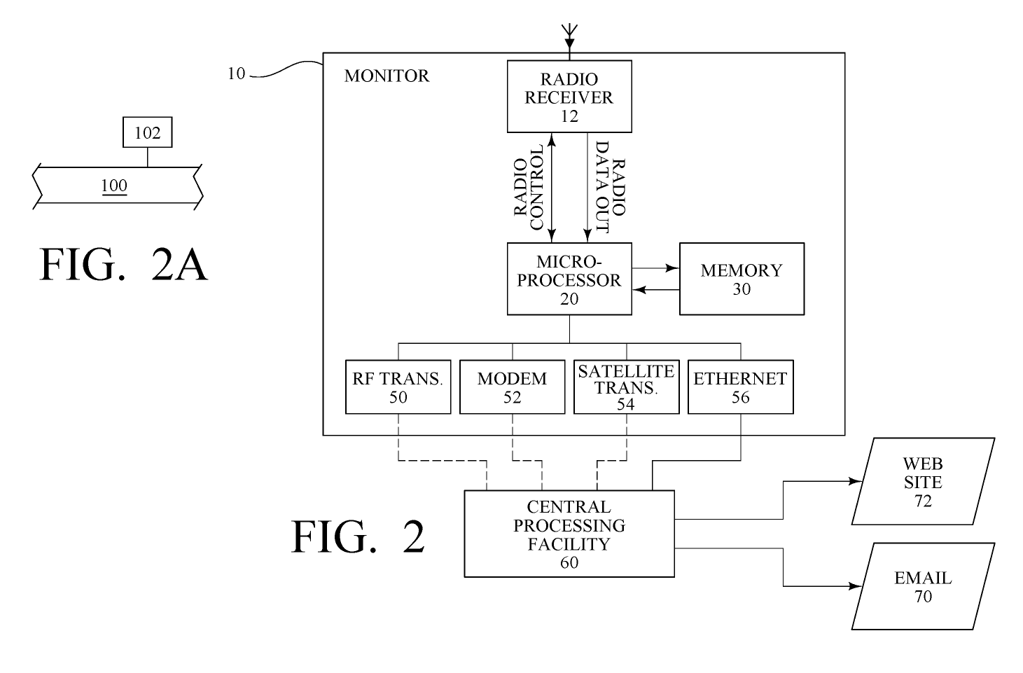

In the method and system of the present invention, and as reflected in FIGS. 2 and 2A, an exemplary monitor 10 thus includes a radio receiver 12 to identify and receive radiofrequency waves associated with the operation of one or more pipelines (or other components) of interest. Each such monitor 10 is positioned at a predetermined location relative to a selected pipeline 100 (or other selected network infrastructure), such that radiofrequency waves from certain meters, gauges, and/or other supervisory devices (as generally indicated by reference numeral 102) associated with the pipeline 100 can be reliably detected.

It is contemplated that various commercially available radio receivers could be used in the monitor 10 to achieve the objectives of the present invention. For example, one preferred radio receiver that is suitable for the purposes of the present invention is selected from the MDS SD Series of radio receivers manufactured and distributed by Digital Energy, a division of General Electric Corporation of Fairfield, Conn. Such radio receivers include models that can receive digitally modulated radio signals in the 100 MHz, 200 MHz, 400 MHz, and 900 MHz ranges. Other radio receivers that are suitable for the purposes of the present invention include: Viper SC radios manufactured and distributed by CalAmp Corporation of Oxnard, Calif.; wireless SCADA radios manufactured and distributed by Freewave Technologies of Boulder, Colo.; and wireless data radios manufactured and distributed by Phoenix Contact of Blomberg, Germany. In certain circumstances, it may be desirable to have a radio receiver that can scan for signals over a wide range of RF frequencies, in which case, another preferred radio receiver that is suitable for the purposes of the present invention is a Mobile BearTracker™ BCT15X scanner manufactured and distributed by Uniden American Corporation of Irving, Tex. As yet another alternative, in certain circumstances, a software-defined radio system may be employed in conjunction with a computer (or microprocessor) in place of commercially available radio receiver hardware.

The predetermined location of the monitor 10 relative to the monitored location (i.e., a selected pipeline 100) can range from being in close proximity (within a few miles) to the monitored location to extremely remote from the monitored location (e.g., using a satellite radio receiver). The predetermined location of the monitor 10 will be determined by parameters which affect radiofrequency propagation distances, including, but not limited to, radio signal frequency, amplitude, line-of-sight, radiofrequency obstructions, and interference.

Referring still to FIG. 2, the exemplary monitor 10 also includes a microprocessor 20 and an associated memory component 30. For example, one preferred microprocessor that is suitable for the purposes of the present invention is an ICO300 embedded system, which is manufactured and distributed by Axiomtek Co., Ltd. of Hsin Tien City, Taiwan. Although not shown in FIG. 2, the exemplary monitor 10 would also include a power supply that provides power to the radio receiver 12, the microprocessor 20, and any other components of the exemplary monitor 10.

The exemplary monitor 10 further includes various circuitry and/or software routines stored in the memory component 30 and carried out by the microprocessor 20 to perform certain operations on the collected signals, as further described below. In other words, the operational steps described below are preferably achieved through the use of a digital computer program, i.e., computer-readable instructions stored in the memory component 30 and executed by the microprocessor 20 of the monitor 10. Such instructions can be coded into a computer-readable form using standard programming techniques and languages, and with benefit of the following description, such programming is readily accomplished by a person of ordinary skill in the art.

In practice, the radio receiver 12 receives and demodulates the digital radio signals from the analog radiofrequency carrier wave and converts them into a digital data stream that is then output from the radio receiver 12, for instance, via a serial port. Alternatively, similar signal conditioning and demodulation steps could be performed by a software routine stored in the memory component 30 and carried by the microprocessor 20. Indeed, such signal conditioning and demodulation steps could be accomplished through various known techniques without departing from the spirit and scope of the present invention.

Once that digital data stream has been output, as part of another software routine stored in the memory component 30 and carried by the microprocessor 20 (i.e., a signal processing and data packaging routine), the digital data stream is separated into discrete data packets. For example, in many cases, the discrete data packets are delimited by silent intervals between messages or delimited by start-of-transmission and/or end-of-transmission (EOT) or end-of-line (EOL) symbols or codes. Additional information may be generated and appended to the discrete data packets including, but not limited to, the date and time of reception of the radio message and/or geolocation information.

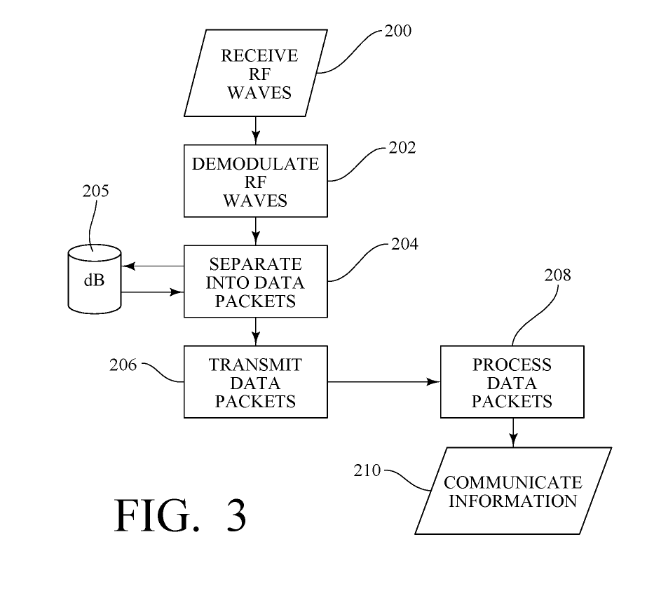

Specifically, the data packets are first processed to identify the radio messaging protocol (or protocols) that was used for the transmission from the meter, gauge, or other supervisory device. In this regard, common messaging protocols used by pipeline operators include both open protocols such as Modbus and DNP3, and semi-proprietary messaging protocols, such as DF1 and DH+. For both the open messaging protocols and semi-proprietary messaging protocols, sufficiently detailed descriptions of the protocol specification are publicly available. For example, the detailed description of the commonly used Modbus specification is available at the following URL: http://www.modbus.org/specs.php. In this regard, information about the transmission frequency, data packaging patterns, and protocols and operating characteristics of the different meters, gauges, and/or other supervisory devices that generate the data is preferably collected from public sources and stored in a database 205, as shown in FIG. 3 and further described below. For any particular data packet, reference can then made to this database 205 of information in order to identify and decode the discrete data packets collected.

As an illustrative example, Table A includes a text file of measured radiofrequency hexadecimal Modbus data packets collected from a monitor for a particular pipeline and sampled at different times and days. Of course, in practice, a permanently installed monitor would ordinarily collect and monitor data continuously (i.e., twenty-four hours per day).

TABLE A

| | | |
|---|---|---|
| 2014-08-21 | 11:23:01 | 04031844ca5f3c44cbd9de42bd351642bef32444b25e1544b45ffcdb3f |
| 2014-08-21 | 11:26:01 | 04031844c9786b44caf15d42c4276742c5f27544b25e1544b45ffcadba |
| 2014-08-21 | 11:29:01 | 04031844c982ec44cafbf342cb189c42ccf0a644b25e1544b45ffc8248 |
| 2014-09-03 | 13:38:40 | 04031844a355c144a57e4e437abd72437e0b6c44b0496744b292c3b8c0 |
| 2014-09-03 | 13:41:46 | 040318449eaa2c44a0c2ec437d82c543806d0f44b0496744b292c348ad |
| 2014-09-03 | 13:44:52 | 040318449d3d3c449f512a43801beb4381cc2c44b04e4344b186c3c403 |
| 2014-09-03 | 13:47:57 | 040318449cfab3449f0dc04381775b43832c3344b0496744b292c3be87 |
| 2014-09-03 | 13:54:17 | 040318449f48c544a1639f43843aa54385f8d644b0496744b292c3cc3e |
| 2014-09-03 | 13:57:22 | 04031844aae1ef44ad24054385a70443876a0644b0496744b292c3095c |
| 2014-09-03 | 14:03:34 | 04031844b8cb0544bb3c2a4388b721438a847f44b0496744b292c31170 |
| 2014-09-03 | 14:06:42 | 04031844c11ce744c3aa31438a5b6b438c2e5744b0496744b292c3a662 |
| 2014-09-03 | 14:15:31 | 04031844cf6d0444d22ab9438f573e43913b0644b0496744b292c3b421 |
| 2014-09-03 | 14:18:36 | 04031844c84ff344caf598439118854393023d44b0496744b292c32cce |
| 2014-09-03 | 14:21:42 | 01031844c18bb244c41s724392c84e4394b7bb44b0496744b292c39e9c |
| 2014-09-03 | 14:24:47 | 04031844ba121d44bc879543946b344396602a44b0496744b292c3288a |
| 2014-09-03 | 14:27:52 | 04031844bd0a0744bf8989439604054397fe6a44b0496744b292c31b0d |
| 2014-09-03 | 14:33:49 | 04031844c5c8ee44c866064399340e439b393344b0496744b292c3bf20 |
| 2014-09-03 | 14:36:54 | 04031844c7c7f644ca6bce439aea3a439cf52944b0496744b292c38095 |

The hexadecimal Modbus data packets typically contain preamble information in the message header, including start-of-transmission codes, routing information for the source and destination of the data packet, and information about the total number of data bytes contained in the message. The data packets also typically contain footer information, including end-of-transmission codes, and error checking codes to ensure error-free data transmission. The central portion of the data packets contains the data payload. The data is typically encoded in the data payload as a series of 32-bit IEEE floating point numbers. The individual 32-bit floating numbers are typically transmitted serially, one after another, with no padding characters and no physical units. Table B shows the basic components of the message, the header information, the data payload, and the message footer separated by spaces.

TABLE B

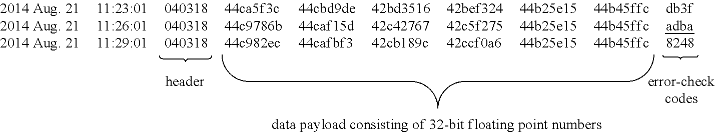

In any event, in this example, once such signal processing and data packaging steps have been completed, the data is essentially in a text log file (or equivalent file format for storing and transmitting ASCII or hexadecimal data characters) that can be readily transmitted to a central processing facility 60 via a communication means, such as, for example, a radio frequency (RF) transceiver 50, a cellular modem 52, a satellite radio transceiver 54, or an Ethernet connection 56. For example, one preferred cellular modem that is suitable for the purposes of the present invention is a Digi TransPort® WR21 cellular router/modem, which is manufactured and distributed by Digi International Inc. of Minnetonka, Minn. Of course, various other data transmission techniques could be employed without departing from the spirit and scope of the present invention, including, but not limited to, microwave communications and/or a fiber optic link. Furthermore, communications may be passed through one or more intermediate locations before receipt at the central processing facility 60.

At the central processing facility 60, further processing of the data packets is carried out via computer (i.e., through the use of a digital computer program). For instance, after determining the beginning and end of the data payload section of each data packet, the 32-bit floating point data can be converted from hexadecimal to decimal numbers using the IEEE-754 single-precision, floating-point standard. Exemplary data converted from the hexadecimal radio data from Table A is presented below in Table C.

TABLE C

| | | A | B | C | D | E | F |
|---|---|---|---|---|---|---|---|
| Aug. 21, 2014 | 11:23:01 | 1618.976 | 1630.808 | 94.60368 | 95.47488 | 1426.94 | 1443 |
| Aug. 21, 2014 | 11:26:01 | 1611.763 | 1623.543 | 98.07696 | 98.97355 | 1426.94 | 1443 |
| Aug. 21, 2014 | 11:29:01 | 1612.091 | 1623.873 | 101.5481 | 102.47 | 1426.94 | 1443 |
| Sep. 3, 2014 | 13:38:40 | 1306.68 | 1323.947 | 250.74 | 254.0446 | 1410.294 | 1428.586 |
| Sep. 3, 2014 | 13:41:46 | 1269.318 | 1286.091 | 253.5108 | 256.852 | 1410.294 | 1428.586 |
| Sep. 3, 2014 | 13:47:57 | 1255.834 | 1272.43 | 258.9325 | 262.3453 | 1410.294 | 1428.586 |
| Sep. 3, 2014 | 13:54:17 | 1274.274 | 1291.113 | 264.4582 | 267.944 | 1410.294 | 1428.586 |
| Sep. 3, 2014 | 13:57:22 | 1367.06 | 1385.126 | 267.3048 | 270.8283 | 1410.294 | 1428.586 |
| Sep. 3, 2014 | 14:03:34 | 1478.344 | 1497.88 | 273.4307 | 277.0351 | 1410.294 | 1428.586 |
| Sep. 3, 2014 | 14:06:42 | 1544.903 | 1565.318 | 276.7142 | 280.362 | 1410.294 | 1428.586 |
| Sep. 3, 2014 | 14:15:31 | 1659.407 | 1681.335 | 286.6816 | 290.4611 | 1410.294 | 1428.586 |
| Sep. 3, 2014 | 14:18:36 | 1602.498 | 1623.675 | 290.1916 | 294.0175 | 1410.294 | 1428.586 |
| Sep. 3, 2014 | 14:21:42 | 1548.365 | 1568.826 | 293.5649 | 297.4354 | 1410.294 | 1428.586 |
| Sep. 3, 2014 | 14:24:47 | 1488.566 | 1508.237 | 296.8375 | 300.7513 | 1410.294 | 1428.586 |
| Sep. 3, 2014 | 14:33:49 | 1582.279 | 1603.188 | 306.4067 | 310.4469 | 1410.294 | 1428.586 |
| Sep. 3, 2014 | 14:36:54 | 1598.249 | 1619.369 | 309.8299 | 313.9153 | 1410.294 | 1428.586 |

The values in each column in Table C are representative of physical natural gas data, including, for example: instantaneous volumetric flow in MMCF/day (million cubic feet per day) (Column A); instantaneous energy flow in BTUs/day (billions of BTUs per day) (Column B); accumulated gas volume delivered so far for that day in MMCF (million cubic feet) (Column C); accumulated energy delivered so far for that day in BTUs (billion BTUs) (Column D); total gas volume delivered yesterday in MMCF (million cubic feet) (Column E); and total energy delivered yesterday in BTUs (billion BTUs) (Column F). With respect to the calculation and reporting of energy flow, the relationship between volume and energy is a factor called “gross calorific value” that ranges between 950 to 1050 BTUs per standard cubic foot of natural gas. The range depends on the composition of the gas. For instance, a greater amount of ethane, propane, and/or butane in the stream leads to “hotter” gas, while pure methane would be closer to 1000 BTUs/cubic foot. Since the composition varies over time, in many cases, there is continuous monitoring and reporting of not only volumetric flow rates, but also energy flow rates along a pipeline. Finally, with respect to such physical natural gas data, in practice, the data type and physical units will not be explicitly detailed in the data packets, but must instead be deduced based on correlation with other sources of information.

Once the flow rate and/or other information about the flow of the natural gas has been determined for one or more pipelines, flow rate and/or other information is then communicated to interested parties. For instance, such communications to interested parties can be achieved through electronic mail delivery and/or through export of the data to an access-controlled Internet web site, as further described below with reference to FIG. 3. Additionally, for any particular natural gas network for which all, or most of, the connected pipelines are monitored in accordance with the present invention, the natural gas flow rate into or out of the network can be determined through a summing of the flow rates on each pipeline, which can also be communicated to interested parties.

From the above description, it should also be clear that once a protocol has been established for processing data from a particular meter, gauge, or other supervisory device, the pipeline associated with that particular meter, gauge, or other supervisory device can be monitored in substantially real-time.

Furthermore, during the measurement time period, other sources of known gas flow can also be monitored and collected, such as publicly available network operational postings, for use as a calibrating dataset and for determining the physical units for the unknown physical quantities. For example, daily gas pipeline nominations can be scraped from natural gas operator postings published on electronic bulletin boards. For instance, the electronic bulletin board for the El Paso Natural Gas Company, L.L.C., a Kinder Morgan company, can be accessed at the following URL: (http://passportebb.elpaso.com/ebbmasterpage/default.aspx?code=EPNG). Such daily pipeline nominations are preferably collected from many such electronic bulletin boards from multiple natural gas pipeline operators, and then stored in a database. For another example, data from other forms of sensors may be collected, stored, and referenced against the collected radiofrequency data. For instance, U.S. Pat. No. 7,274,996, which is incorporated herein by reference, describes a method and system for monitoring fluid flow, such as fluid flow through pipelines or similar conduits for delivering natural gas, crude oil, and other similar liquid or gas energy commodities, that relies on the measurement of acoustic waves generated by the fluid, thus allowing for monitoring of the flow rate without direct access to the fluid. Additionally, U.S. Pat. No. 7,376,522, which is also incorporated herein by reference, describes a method and system for determining the direction of fluid flow through the use of one or more sound transducers positioned in proximity to a pipeline or similar conduit.

Furthermore, acoustic and other physical signals can be detected using non-radiofrequency sensors from various points on a pipeline, such as at a meter or compressor station. Frequently, stronger signals are associated with operational start-ups and shut-downs of a facility on the pipeline. When combined with the more detailed operational signals obtained through monitoring the radiofrequency space associated with the meter or compressor station, the use of combined technologies can be used to define patterns of SCADA transmission associated with start-ups, shut-downs, or malfunctions. Specific radiofrequency message types can thus be learned over time by combining radiofrequency and other measurement methodologies.

FIG. 3 is a flow chart that further illustrates the core steps of an exemplary method for monitoring a network of one or more pipelines for a commodity in accordance with the present invention. Once a monitor is positioned at a predetermined location, a radio receiver of the monitor is used to receive radiofrequency waves from one or more supervisory devices associated with a component in the network, as indicated by input 200 of FIG. 3. Then, the radiofrequency waves are demodulated and converted into a digital data stream, as indicated by block 202 of FIG. 3. The digital data stream is then separated into discrete data packets, as indicated by block 204 of FIG. 3, with reference being made to the database 205 in order to identify and decode the discrete data packets. The discrete data packets are transmitted to a central processing facility, as indicated by block 206 of FIG. 3. At the central processing facility, the discrete data packets are processed to determine information about the commodity relative to the component, as indicated by block 208 of FIG. 3. Finally, such information about the commodity relative to the component, such as the flow rate of the commodity through a pipeline, is communicated to interested parties, as indicated by output 210 of FIG. 3. For instance, such communications to interested parties can be achieved through electronic mail delivery (as indicated by reference number 70) and/or through export of the data to an access-controlled Internet web site (as indicated by reference number 72), which interested parties can access through a common Internet browser program, such as Microsoft Edge, Google Chrome, Mozilla Firefox, Safari, or other similar desktop or mobile device browser.

One of ordinary skill in the art will recognize that additional embodiments and implementations are also possible without departing from the teachings of the present invention. This detailed description, and particularly the specific details of the exemplary embodiments and implementations disclosed therein, is given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A method for monitoring a component of a network for a commodity, comprising the steps of:
positioning a monitor at a predetermined location, said monitor including a radio receiver;
using the radio receiver to receive radiofrequency waves from a supervisory device associated with the component of the network;
demodulating the radiofrequency waves and converting them into a digital data stream;
separating the digital data stream into discrete data packets;
processing the discrete data packets to determine information about the commodity relative to the component; and
communicating the information about the commodity to an interested party.

2. The method as recited in claim 1, and further comprising the step of transmitting the discrete data packets to a central processing facility for the subsequent step of processing the discrete data packets to determine the information about the commodity before communicating the information to the interested party.

3. The method as recited in claim 1, and further comprising the step of transmitting the digital data stream to a central processing facility for the subsequent steps of separating the digital data stream into the discrete data packets and processing the discrete data packets to determine the information about the commodity before communicating the information to the interested party.

4. The method as recited in claim 1, wherein the monitor includes a microprocessor that executes computer-readable instructions stored in a memory component to separate the digital data stream into discrete data packets.

5. The method as recited in claim 4, wherein, as part of the step of processing the discrete data packets, a database is accessed to identify a messaging protocol.

6. The method as recited in claim 1, wherein the predetermined location of the monitor is aboard a satellite, and a satellite radio receiver serves as the radio receiver of the monitor to receive radiofrequency waves from the supervisory device associated with the component of the network.

7. A method for monitoring a pipeline for a commodity, comprising the steps of:
positioning a monitor at a predetermined location, said monitor including a radio receiver;
using the radio receiver to receive radiofrequency waves from a supervisory device associated with the pipeline;
demodulating the radiofrequency waves and converting them into a digital data stream;
separating the digital data stream into discrete data packets;
processing the discrete data packets to determine information about flow of the commodity through the pipeline; and
communicating the information about the flow of the commodity through the pipeline to an interested party.

8. The method as recited in claim 7, and further comprising the step of transmitting the discrete data packets to a central processing facility for the subsequent step of processing the discrete data packets to determine the information about the flow of the commodity before communicating the information to the interested party.

9. The method as recited in claim 7, and further comprising the step of transmitting the digital data stream to a central processing facility for the subsequent steps of separating the digital data stream into the discrete data packets and processing the discrete data packets to determine the information about the flow of the commodity before communicating the information to the interested party.

10. The method as recited in claim 7, wherein the monitor includes a microprocessor that executes computer-readable instructions stored in a memory component to separate the digital data stream into discrete data packets.

11. The method as recited in claim 10, wherein, as part of the step of processing the discrete data packets, a database is accessed to identify a messaging protocol.

12. The method as recited in claim 7, wherein the predetermined location of the monitor is aboard a satellite, and a satellite radio receiver serves as the radio receiver of the monitor to receive radiofrequency waves from the supervisory device associated with the pipeline.

13. The method as recited in claim 7, wherein the commodity is natural gas.

14. The method as recited in claim 7, wherein the commodity is crude oil.

15. The method as recited in claim 7, wherein the information about the flow of the commodity is a volumetric flow rate.

16. The method as recited in claim 7, wherein the information about the flow of the commodity is an energy flow rate.

17. A monitor positioned at a predetermined location relative to a component of a network for a commodity, comprising:
a radio receiver that (i) receives radiofrequency waves from a supervisory device associated with the component of the network, (ii) demodulates the radiofrequency waves, and (iii) outputs a digital data stream;
a microprocessor that (i) receives the digital data stream from the radio receiver, (ii) executes computer-readable instructions stored in a memory component to separate the digital data stream into discrete data packets, and (iii) outputs the discrete data packets; and
a communication means that (i) receives the discrete data packets from the microprocessor, and (ii) transmits the discrete data packets to a central processing facility for subsequent processing of the discrete data packets to determine information about the commodity relative to the component.

18. The monitor as recited in claim 17, wherein the component is a pipeline.

19. The monitor as recited in claim 17, wherein the commodity is natural gas.

20. The monitor as recited in claim 17, wherein the commodity is crude oil.
